(19) United States
(12) Patent Application Publication
(10) Pub. No.: US 2026/0092241 A1
(43) Pub. Date: Apr. 2, 2026

(54) EFFERVESCENT CLEANING COMPOSITION IN TABLET FORM

(71) Applicant: KP MEDICAL LTD, London (GB)

(72) Inventor: Christian Mark Lawson-Statham, London (GB)

(73) Assignee: KP MEDICAL LTD, London (GB)

(21) Appl. No.: 19/345,362

(22) Filed: Sep. 30, 2025

(30) Foreign Application Priority Data
Sep. 30, 2024 (GB) 2414338.0
Apr. 2, 2025 (GB) 2504964.4
Apr. 2, 2025 (GB) 2504966.9

(51) Int. Cl. C11D 17/00; B08B 3/12; C11D 1/10; C11D 3/00; C11D 3/10; C11D 3/20

(52) U.S. Cl. CPC C11D 17/0073; B08B 3/12; C11D 1/10; C11D 3/0005; C11D 3/10; C11D 3/2075; C11D 2111/46

(57) ABSTRACT

An effervescent cleaning composition in the form of a tablet for the cleaning of oral appliances in an ultrasonic cleaning device, wherein the tablet has a first face and a second face, the first face and second face opposing one another in a depth direction of the tablet, wherein the first face is provided with a depression, wherein the depression provides the tablet with a minimum dimension in the depth direction that is 50 to 90% of the maximum dimension of the tablet in the depth direction and wherein the maximum dimension of the depression in a direction which is perpendicular to the depth direction is 40 to 70% of the dimension of the tablet in the same direction, being perpendicular to the depth direction. The tablet is adapted to dissolve in water and, as it dissolves, an aperture is formed in the tablet in the depth direction at the site of the depression.

The present invention relates to an effervescent cleaning composition in tablet form for use in ultrasonic cleaning. In particular, the present invention relates to an effervescent cleaning composition in tablet form for the cleaning of oral appliances.

Over time, poorly maintained oral appliances can accumulate bacteria and plaque, which contribute to a range of oral health issues, including bad breath and cavities. Ultrasonic cleaning technology has been used in clinical dental settings for many decades due to its safety and reliability. In recent years, ultrasound cleaning technology has been adapted for personal use.

Oral appliances suitable for ultrasonic cleaning include clear aligners, retainers (including those with metal), mouth guards, dentures, bite guards (night guards), sleep apnoea devices, toothbrush heads and snore guards.

Ultrasonic cleaning is useful for eliminating bacteria, viruses and pathogens, keeping oral appliances looking clean, removing harmful plaque build-up and saving a user time and effort.

During ultrasonic cleaning, an oral appliance is placed in a solution and subjected to high-frequency ultrasonic waves which vibrate the solution and produce millions of nano-scale bubbles. These bubbles rapidly expand and collapse, releasing a large amount of energy and continuously removing grime, bacteria and plaque while being non-abrasive to the oral appliance. This cavitation action can provide effective cleaning in a few minutes of exposure of the oral appliance to ultrasonic waves. The lack of abrasion using ultrasonic cleaning is beneficial as there is a much-reduced risk of causing micro-abrasions which might harbour bacteria and compromise the appearance of the oral appliance.

Effervescent cleaning compositions in tablet form are commonly used in combination with ultrasonic cleaning: the chemicals in the composition may be used for sterilisation purposes. In this respect, such compositions are water-soluble and typically contain an active ingredient having antimicrobial properties, an alkali metal bicarbonate and a solid aliphatic carboxylic acid. In use, the tablets are dissolved in water, resulting in the bicarbonate and acid components reacting to release carbon dioxide. After the tablet has dissolved, the ultrasonic cleaning begins.

Cosmetic dental appliances, such as clear plastic aligners, are increasingly popular. Such aligners may be worn for up to 22 hours a day and so there is a need for effective and quick cleaning to maintain the discreet aesthetic look and to preserve oral health.

The present invention seeks to provide an improved effervescent cleaning composition in tablet form for use in ultrasonic cleaning.

According to the present invention in a first aspect there is provided an effervescent cleaning composition in the form of a tablet for the cleaning of oral appliances in an ultrasonic cleaning device, wherein the tablet has a first face and a second face, the first face and second face opposing one another in a depth direction of the tablet, wherein the first face is provided with a depression, wherein the depression provides the tablet with a minimum dimension in the depth direction that is 50 to 90% of a maximum dimension of the tablet in the depth direction and wherein a maximum dimension of the depression in a direction which is perpendicular to the depth direction is 40 to 70% of a dimension of the tablet in the same direction, being a direction perpendicular to the depth direction.

Preferably, the minimum dimension of the tablet in the depth direction is 70 to 90% of the maximum dimension of the tablet in the depth direction. For example, the minimum dimension of the tablet in the depth direction is 75 to 85% of the maximum dimension of the tablet in the depth direction.

Preferably, the maximum dimension of the depression in the direction which is perpendicular to the depth direction is 40 to 60% of the dimension of the tablet in the same direction, being a direction perpendicular to the depth direction. For example, the maximum dimension of the depression in the direction which is perpendicular to the depth direction is 45 to 55% of the dimension of the tablet in the same direction.

The maximum dimension of the depression in the direction which is perpendicular to the depth direction and the dimension of the tablet in the same direction are measurable in plan view. The dimension of the tablet is the maximum dimension of the tablet in this direction, being perpendicular to the depth direction.

The depression is preferably circular in plan view. The tablet may also be circular in plan view.

Other shapes of the tablet and depression are envisaged. For example, a circular depression may be formed in a tablet which is oval-shaped in plan view, or an oval depression may be formed in an tablet which is oval-shaped or circular in plan view. Square or rectangular shapes for the depression and/or tablet in plan view are also envisaged but are less preferred.

When the tablet is circular in plan view, the maximum dimension of the tablet in the direction which is perpendicular to the depth direction is the diameter of the tablet. When the depression is circular in plan view, the maximum dimension of the depression in the direction which is perpendicular to the depth direction is the maximum diameter of the depression. When the tablet and/or depression have other shapes in plan view, the maximum dimensions are the longest dimensions in the width or length directions.

The tablet, when circular in plan view, may have a maximum diameter in the range of 16 to 20 mm and preferably of about 18 mm. The tablet may have a maximum depth in the range of 4.5 to 5.5 mm and preferably of about 5 mm, for example 5.1 mm.

The depression may have a maximum diameter in the range of 7 to 11 mm and preferably of about 9 mm. The depression may have a maximum depth in the range of 0.8 to 1.2 mm and preferably of about 1 mm.

When both the tablet and the depression are circular in plan view, the tablet is adapted to form a ring-shape when it is dissolving; the aperture is approximately circular in plan view.

Known cleaning tablets commonly have a substantially-cylindrical shape which may be provided with convex faces. The applicant has an existing cleaning tablet, sold under the brand name ZIMA DENTAL™, which is in the shape of a flat cylinder. These tablets do not form ring-shapes as they dissolve.

Known cleaning tablets are used in ultrasonic cleaning devices to clean oral appliances. An ultrasonic cleaning device may comprise a tank and an ultrasonic transducer to convey ultrasonic waves to a liquid in the tank.

The applicant has an ultrasonic cleaning device with a cylindrical tank defining an internal cleaning chamber for receiving one or more oral appliances. An ultrasonic transducer is located externally of the cleaning chamber and adjacent a base portion of the tank.

To clean the oral appliance, the tank of the ultrasonic cleaning device is filled with liquid (usually water); one or more oral appliances are introduced into the tank together with the cleaning tablet (either before or after the tank is filled with liquid); and the ultrasonic transducer is driven such that the liquid is vibrated with ultrasonic waves to clean the or each oral appliance while the tablet dissolves in the liquid to clean the oral appliance.

In contrast to known cleaning tablets, the tablet of the present invention has been specially formulated and configured for ultrasonic use. It acts as both an antimicrobial agent and an ultrasonic improvement agent.

During use of the tablet of the present invention, the first face with the depression is an upper face and the second face is a lower face which is adjacent the base of the tank.

The lower face may be configured to contact the base of the tank and is preferably substantially planar to sit stably on the tank base.

The upper face is directed towards the tank opening and is preferably directed towards an oral appliance placed in the tank.

The present inventor has surprisingly discovered that the provision of a depression in a face of an effervescent tablet is beneficial during ultrasonic cleaning. The presence of the depression increases the surface area of the tablet such that it dissolves more quickly. Also, as a result of the depression, the tablet dissolves inwardly at the location of the depression: the high surface area of the depression and the reduced depth of the tablet at this point causes the tablet to dissolve more quickly at the location of the depression. This property of dissolving inwardly improves the stability of the tablet during ultrasonic cleaning.

Moreover, as the tablet dissolves inwardly, an aperture is formed, starting at the location where the tablet has its minimum dimension in the depth direction. This aperture releases bubbles which would otherwise be trapped beneath the tablet and cause the tablet to float upwards during the ultrasonic cleaning. The presence of the depression and the resulting aperture formed in the dissolving tablet seek to prevent floating of the tablet during cleaning, such that the tablet remains generally in position. This position is preferably above the ultrasonic transducer and below an oral appliance being cleaned. In contrast, prior art cleaning tablets have a tendency to float out of position when they dissolve and this is detrimental to effective and efficient cleaning: the standard flat-shape tablets of the prior art start to dissolve into the shape of a disc which moves around the tank due to trapped gas bubbles and the effect of the applied ultrasound.

According to the present invention there is also provided an effervescent cleaning composition in the form of a tablet for the cleaning of oral appliances in an ultrasonic cleaning device, wherein the tablet has a first face and a second face, the first face and the second face opposing one another in a depth direction of the tablet, wherein the first face is provided with a depression, wherein the tablet is adapted to dissolve in water and wherein the tablet is configured such that, as it dissolves, an aperture is formed in the tablet in the depth direction at the site of the depression.

The depression is preferably located substantially-centrally in the first face of the tablet such that, as the tablet dissolves, the aperture is formed substantially-centrally to assist stable positioning of the tablet. The dissolving shape of the tablet is then more likely to stay close to the location of the ultrasonic transducer and this is beneficial to achieving better ultrasonic cleaning of an oral appliance.

The depression is preferably concave, meaning that it has a surface which curves inwardly. In one example, its surface curves inwardly like the surface of a spherical cap.

Providing a concave depression is beneficial as the curved surface may act like a lens, focusing the carbon dioxide gas released into a more concentrated flow of bubbles. As the tablet dissolves and the gas bubbles rise, the curvature may direct the stream of bubbles towards an oral appliance located above the tablet, enhancing the cleaning effect. Preferably, the curved surface of the depression acts to concentrate bubbles in narrow stream: this high concentration of bubbles causes a chain reaction of bubble formation and cavitation.

A non-concave depression with substantially-flat surfaces and therefore relatively sharp edges may be used instead but it is likely to release the gas bubbles in a less uniform way, reducing the positive cleaning effect.

Further, such sharp edges are more prone to chipping or breaking off, which can cause the tablet to dissolve unevenly and release bubbles inconsistently. Providing a curved surface in a concave depression means that the tablet is less likely to break, preserving the tablet's structure during dissolution.

Another advantage of a concave depression is that the tablet can be ‘pushed’ and held initially with the end of finger into correct placement (above the ultrasonic transducer) using the depression rather than being dropped into the tank in the wrong place.

The chosen geometry of the depression balances the desired cavitational effect with tablet stability.

The depression is sized and shaped such that, as the tablet dissolves in water, an aperture is formed in the tablet at the site of the depression.

The first face of the tablet may have the shape of a spherical cap with the depression provided therein. The first face of the tablet, absent the depression, may have the shape of a spherical cap. The depression may have the shape of a spherical cap. The spherical cap of the first face and the spherical cap of the depression may be co-axial.

A flat cylinder portion may be provided between the first face and the second face of the tablet.

The second face of the tablet is preferably substantially planar and may include one or more small indentations to increase the surface area of the tablet. The indentations may be in the form of a brand logo, for example.

The tablet may have a weight in the range of 1 to 2 g, preferably it has a weight in the range of 1.2 to 1.8 g and more preferably it has a weight in the range of 1.5 to 1.7 g. In one example, the tablet has a weight in the range of 1.5 to 1.6 g.

In contrast, prior art effervescent cleaning compositions in the form of a tablet for the cleaning of oral appliances in an ultrasonic cleaning device generally have a weight which is more than 2 g and may be in the range of 2.4 to 2.9 g.

Preferably, the tablet of the present invention has a lower weight and/or a higher surface area to volume ratio than prior art cleaning tablets.

The tablet of the present invention may have a surface area to volume ratio of more than 0.6/m, preferably more than 0.65/m. In one embodiment, this ratio is more than 0.68/m.

In addition to the presence of the depression, the effervescent cleaning composition of the tablet has a carefully balanced formulation.

As explained in more detail below, the effervescent cleaning composition has been specifically formulated by the inventor to enhance ultrasonic cavitation by optimizing water tension, wetting ability and viscosity. These factors provide effective and enhanced ultrasonic cleaning.

In this respect, the effervescent cleaning composition comprises at least one oxidising agent, at least one surfactant and effervescing agents.

Examples of a suitable oxidising agent are one or more of sodium percarbonate, sodium perborate and hydrogen peroxide. The tablet is therefore an antimicrobial agent and may be a sterilising tablet. The effervescent cleaning composition may comprise 10 to 25 wt % oxidising agent, preferably 10 to 20 wt % oxidising agent.

The effervescing agents may comprise at least one organic carboxylic acid and at least one alkali metal carbonate and/or bicarbonate. The organic carboxylic acid may be citric acid, tartaric acid and/or gluconic acid. The alkali metal compound may be sodium carbonate, sodium bicarbonate, potassium carbonate and/or potassium bicarbonate.

The effervescent cleaning composition may comprise 60 to 75 wt % effervescing agents, preferably 65 to 70 wt % effervescing agents. In this respect, the composition may comprise at least 38 wt % alkali metal carbonate and/or bicarbonate and at least 22 wt % organic carboxylic acid.

The or each surfactant preferably has its origin in natural products: it may be naturally-sourced or synthesised. By way of example, the surfactant(s) may be derived from coconut oil or corn starch.

The surfactant or surfactants may be selected from those listed below.

Derived from Coconut Oil:
Disodium Cocoyl Glutamate
Sodium Cocoyl Glutamate
Coco Glucoside (also from glucose)
Lauryl Glucoside (also from glucose)
Coco Betaine
Sodium Coco Sulphate
Sucrose Cocoate (also from sucrose)
Caprylyl/Capryl Glucoside (also from glucose)
Sodium Cocoyl Isethionate
Coco Betaine
   Derived from Glucose (Usually from Corn Starch):
Coco Glucoside (also from coconut oil) Decyl Glucoside
Lauryl Glucoside (also from coconut oil)
Caprylyl/Capryl Glucoside (also from coconut oil)

### Plant-Based:

Soap Nuts (Soap Berries, Aritha)
Liquid Yucca Extract
Shikakai Powder
Soapwort
Saponified Olive Oil (from olive oil)

### Synthetic:

Disodium Laureth Sulfosuccinate

In one example, the effervescent cleaning composition comprises 0.7 to 2.5 wt %, preferably 1.5 to 2.5 wt %, of Disodium Cocoyl Glutamate as a surfactant.

The effervescent cleaning composition of the present invention does not contain sodium benzoate in view of concerns regarding its possible detriment to human health. For similar reasons, the composition does not contain persulphates such as potassium peroxymonosulfate.

The effervescent cleaning composition of the present invention preferably comprises ingredients which are derived from natural products: the ingredients may be naturally-sourced or synthesised.

The cleaning composition seeks to provide a lower concentration of chemicals and to rely on naturally-derived ingredients to enhance cleaning performance and to reduce the potential for harmful residues. This provides a more environmentally-friendly and safer alternative to prior art cleaning compositions.

As explained below, the properties of the ingredients of the effervescent cleaning composition of the tablet also enhance the ultrasonic cavitation process. The improved cavitation results in more vigorous and effective micro-bubble action, leading to a deeper and more thorough cleaning of oral appliances, without causing any damage to their delicate structures.

Water Tension: Surfactants decreases the surface tension of water. Lower water tension means the cleaning solution can more easily penetrate microscopically small crevices in oral appliances, allowing the ultrasonic waves to reach and clean more effectively. Lower water tension also makes it easier for cavitation bubbles to form during ultrasonic cleaning.

Wetting Ability: By improving the wetting ability of the solution, ingredients like sodium bicarbonate and citric acid ensure that the liquid spreads uniformly over the appliance. This uniform coverage is essential for thorough cleaning as it allows the ultrasonic waves to act more efficiently across the entire surface of the appliance.

Viscosity: The formulation avoids ingredients that would overly thicken the solution, as high viscosity can dampen ultrasonic activity. A thinner solution, achieved without compromising cleaning efficacy, allows for better transmission of ultrasonic waves and more effective cavitation (the formation and collapse of microscopic bubbles that help dislodge and remove debris).

The effervescent cleaning composition of the tablet of the present invention therefore has a carefully balanced formulation, providing a reduced concentration in a tank of water while providing superior effervescence and using one or more gentle surfactants.

In one embodiment of the present invention, the effervescent cleaning composition of the tablet comprises:
18 to 28 wt % Sodium Bicarbonate
22 to 32 wt % Citric Acid
12 to 22 wt % Sodium carbonate
12 to 22 wt % Sodium percarbonate
0.7 to 2.5 wt % Disodium cocoyl glutamate and
optionally one or more of:
8 to 18 wt % Maltodextrin
3 to 9 wt % Sodium sulphate
2 to 9 wt % Potassium sulphate
0.1 to 1 wt % mint flavour (eg Peppermint oil)

This tablet composition has been found to enhance cavitation, which is key for a better cleaning performance in ultrasonic cleaning devices. The shape of the tablet, with the depression in one of its faces, also contributes to enhancing the cleaning performance.

According to the present invention in another aspect, there is provided use of an effervescent cleaning composition in the form of a tablet in an ultrasonic cleaning device for the cleaning of oral appliances.

In a further aspect of the present invention, there is provided an effervescent cleaning composition in the form of a tablet and an ultrasonic cleaning device, wherein the device comprises a tank and an ultrasonic transducer to convey ultrasonic waves to the tablet and a liquid in the tank.

In yet a further aspect of the present invention, there is provided an ultrasonic cleaning method for oral appliances using an effervescent cleaning composition in the form of a tablet and an ultrasonic cleaning device, the method comprising: introducing the tablet, liquid and one or more oral appliances into the ultrasonic cleaning device; driving an ultrasonic transducer of the ultrasonic cleaning device; and vibrating the liquid with ultrasonic waves and dissolving the tablet in the liquid to clean the or each oral appliance.

A tablet-based system according to the present invention offers a simple “drop-and-clean” solution that can be easily integrated into consumer devices.

The time period for which the ultrasonic transducer is driven may be from 2 minutes to 15 minutes, preferably from 3 minutes to 10 minutes, more preferably about 5 minutes.

In conventional cleaning methods, the advice provided to users is to allow the tablet (or other form of cleaning composition) to fully dissolve in the liquid before vibrating the liquid with ultrasonic waves.

In the present invention, the liquid is vibrated with ultrasonic waves while dissolving the tablet in the liquid, therefore attaining the beneficial effects mentioned herein.

In an alternative aspect, there is provided an ultrasonic cleaning method for oral appliances using an effervescent cleaning composition in the form of a tablet and an ultrasonic cleaning device, the method comprising: introducing liquid and one or more oral appliances into the ultrasonic cleaning device, driving an ultrasonic transducer of the ultrasonic cleaning device for a first period of time, vibrating the liquid with ultrasonic waves to clean the or each oral appliance during the first period, adding the tablet to the liquid in the ultrasonic cleaning device after the first period, driving the ultrasonic transducer of the ultrasonic cleaning device for a second period of time, and vibrating the liquid with ultrasonic waves while dissolving the tablet in the liquid to clean the or each oral appliance during the second period.

During the first and second periods, the amplitude of the ultrasonic signal preferably remains substantially unchanged. The first and second periods may be continuous or discontinuous.

The present inventor has found that adding and dissolving the tablet in the liquid increases the ultrasonic frequency experienced by the oral appliance in the second period by at least 220%, preferably by at least 250% and more preferably by about 300%. In effect, the fundamental frequency of the cleaning solution is raised.

This has the following benefits on the effectiveness of the cleaning of the oral appliance.

During the first period, the ultrasonic frequency experienced by the oral appliance is relatively low and this provides a relatively strong cleaning effect; a more aggressive scrubbing action occurs.

During the second period, when the tablet is present, the ultrasonic frequency experienced by the oral appliance is relatively high and this provides a more thorough cleaning effect; a less aggressive scrubbing action occurs that has better penetration into the complex and unique morphological recesses of the oral appliance.

Also, lower frequencies may remove large particles more effectively while higher frequencies may remove smaller particles more effectively.

A ‘modulation’ approach is therefore possible and this offers the benefit of dual-frequency action, combining the cleaning advantages of the lower and higher frequencies and providing a more effective cleaning outcome compared to either using the liquid without the tablet or using the tablet in the liquid throughout the cleaning process by dissolving the tablet in the liquid prior to vibrating the liquid with ultrasound.

The present inventor has demonstrated that the tablet of the present invention provides a more pronounced frequency-modulation effect than prior art effervescent cleaning tablets.

This is attributable to the configuration of the tablet which provides an effective bubble stream and has improved placement so that it moves less in the liquid compared to existing cleaning tablets.

The present invention therefore provides a dual-action approach to cleaning, where frequency-modulation via the use of effervescing agents is combined with a unique tablet geometry to provide a synergistic effect. An initial low-frequency phase dislodges bulk contaminants, while the high-frequency phase, triggered by the tablet's controlled dissolution, reaches into micro-crevices for thorough removal of bacteria and plaque.

The tablet's configuration ensures a stable, controlled release of effervescence, which minimizes variation in cleaning performance. This leads to a more consistent and predictable cleaning process compared to conventional tablets that float and dissolve unevenly.

By adding a tablet in the course of a cleaning cycle, oral appliances can experience both strong (low frequency) and thorough (high frequency) cleaning in the same ultrasonic cleaning device.

The first period and the second period can be from 2 minutes to 15 minutes long in total with each time period preferably being from 1 minutes to 5 minutes, more preferably from 2 minutes to 3 minutes, most preferably 2.5 minutes long. The first time period can be the same as the second time period. The first time period and the second time period can each be 1, 2, 3, 4, 5, 6, 7 or 8 minutes long. The first and second time periods can each be at least 50 seconds, 100 seconds, 120 seconds, 150 seconds long.

The tablet is added after the first period and so is not present in the first period. As soon as the tablet is added and starts dissolving, the second period preferably begins. The second period may end before or after the tablet has completely dissolved which may take 5 minutes, for example.

A user may have the option to control when frequency modulation occurs. A user may opt for the frequency-modulation effect to last the time it takes for the cleaning composition to fully dissolve in the liquid.

The present inventor has found that it is advantageous to start the second time period as soon as the tablet has been added, such that the ultrasonic transducer of the ultrasonic cleaning device is preferably immediately driven for a second period of time once the cleaning composition has been added to the liquid. In this way the effervescence caused by the tablet can interact with the ultrasonic cleaning device to modulate the ultrasonic frequency experienced in the ultrasonic cleaning device, e.g. by the oral appliance. The significance of starting the ultrasonic cleaning substantially concomitantly with the addition of the tablet has not previously been recognised. Typically, instruction leaflets provided with tablets advise the user to let the tablet fully dissolve before starting cleaning.

In a preferred embodiment, the tablet is added approximately mid-way through the cleaning cycle, such that the first and second periods are approximately the same length of time.

According to the present invention there is also provided an effervescent cleaning composition in the form of a tablet for the cleaning of oral appliances in an ultrasonic cleaning device, wherein the tablet has a first face and a second face, the first face and the second face opposing one another in a depth direction of the tablet, wherein the first face is provided with a depression, wherein the tablet is adapted to dissolve in water and wherein the tablet is configured such that, as it dissolves, an aperture is formed in the tablet in the depth direction at the site of the depression and the ultrasonic frequency experienced by the oral appliance being cleaned is increased.

The present invention further provides use of an effervescent cleaning composition in the form of a tablet as modulator of ultrasonic frequency in an ultrasonic cleaning device.

In particular, the use of effervescing agents in the manufacture of a cleaning composition for increasing the ultrasonic frequency experienced by one or more objects being cleaned in a liquid in an ultrasonic cleaning device.

The bubbles created when the effervescing agents dissolve in the liquid envelop the object(s) and the ultrasonic waves produced by the ultrasonic cleaning device are modulated by the presence of these bubbles.

By the use of effervescing agents in the manufacture of a cleaning composition, the ultrasonic frequency experienced by one or more objects being cleaned in an ultrasonic cleaning device is increased and the cleaning action is modified.

By relying on chemical modulation instead of complex electrical or mechanical systems, the approach reduces the overall system complexity. This can result in lower manufacturing costs, reduced maintenance requirements, and improved device longevity.

The chemical modulation mechanism can be less energy-intensive compared to electronic frequency modulators. Additionally, it may reduce unwanted heat generation in the cleaning device, which is beneficial for cleaning delicate objects such as sensitive oral appliances.

Also, the randomness in bubble distribution as the tablet dissolves effervescently may cause abrupt, rapid changes in the frequencies experienced by the object being cleaned, creating a synergistic dual cleaning effect. Such abrupt changes are not possible using mechanical and electrical means for providing different frequencies.

The present invention will now be described, by way of example only, by reference to the following examples and the following schematic drawings where:

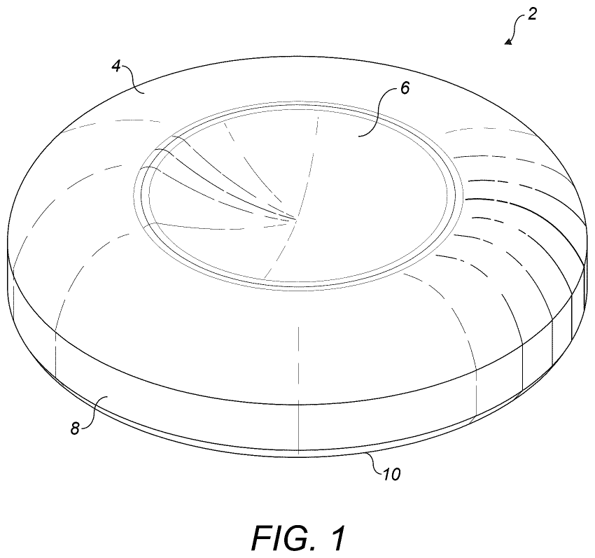

FIG. 1 is a front and side perspective view of a tablet in accordance with the present invention;

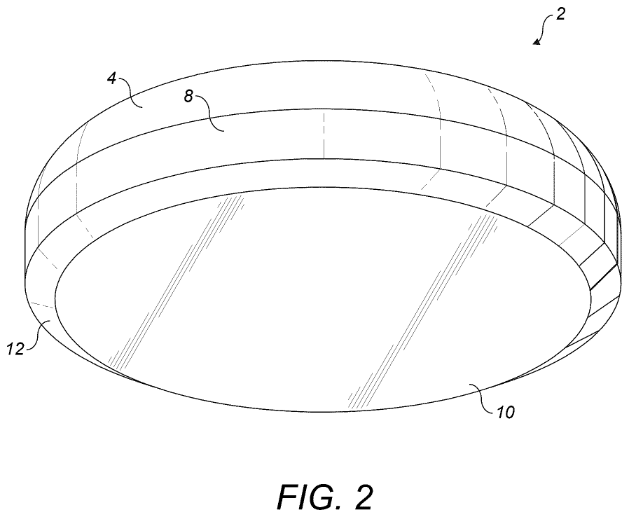

FIG. 2 is a rear and side perspective view of the tablet of FIG. 1;

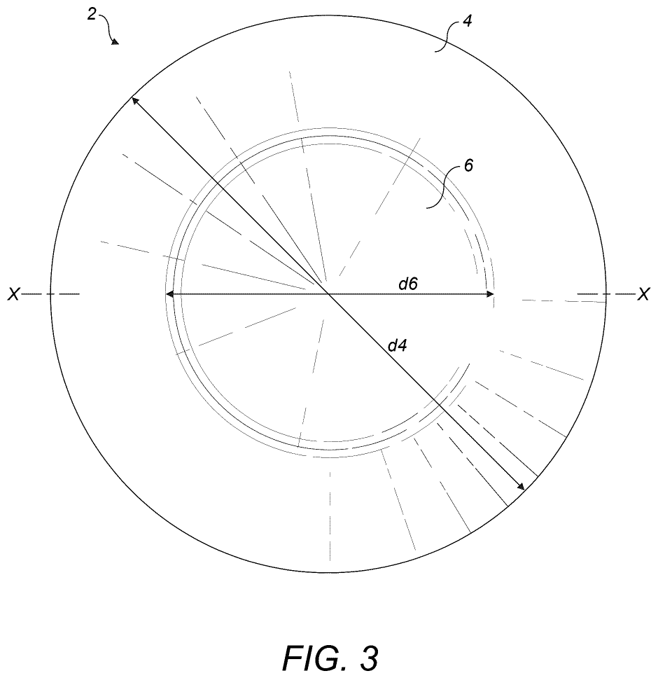

FIG. 3 is a plan view of a front face of the tablet of FIG. 1;

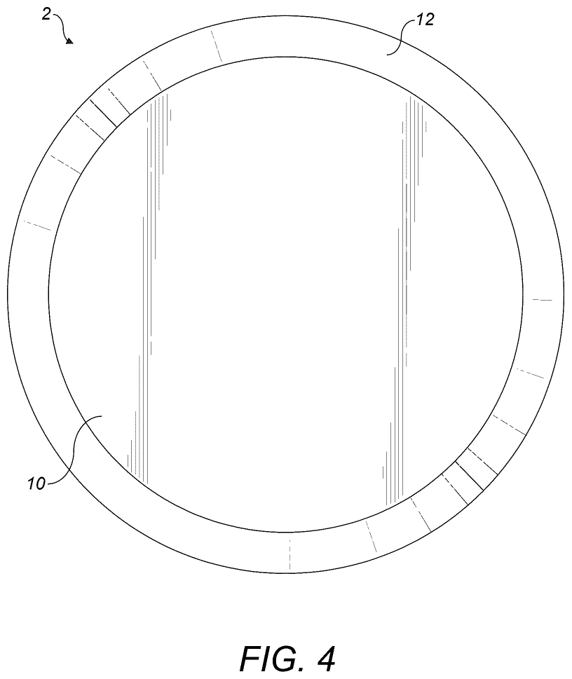

FIG. 4 is a plan view of a rear face of the tablet of FIG. 1;

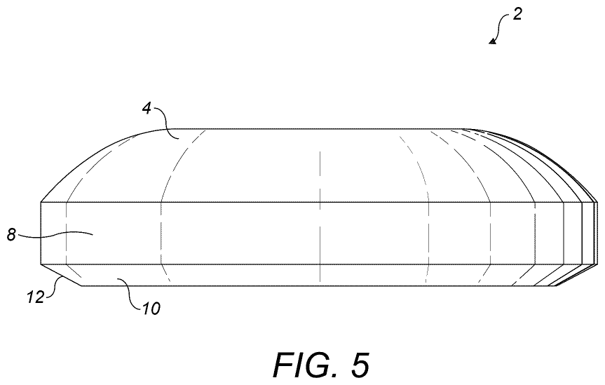

FIG. 5 is a side view of the tablet of FIG. 1;

FIG. 6 is a cross-sectional view of the tablet of FIG. 1, taken through line X-X of FIG. 3;

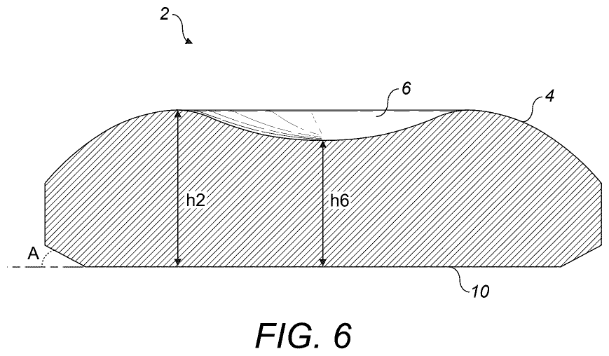

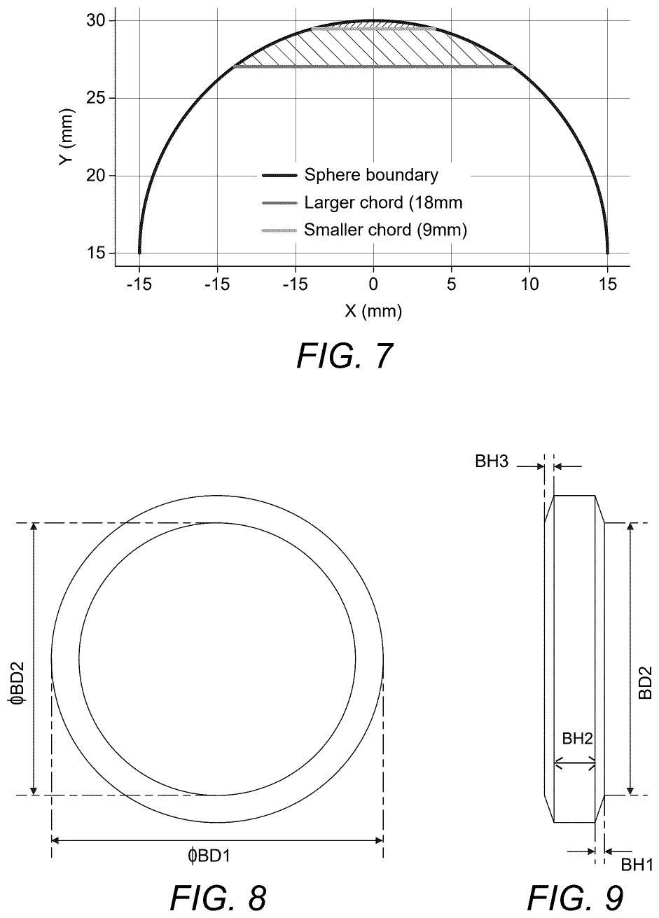

FIG. 7 is a graph of a hemi-sphere;

FIG. 8 is a plan view of a prior art tablet; and

FIG. 9 is a side view of the prior art tablet.

In FIGS. 1 to 6, according to one embodiment of the present invention, a tablet 2 is circular in plan view and has the geometry described below.

The tablet shape has four distinct regions which are co-axial; a front face 4, a concave depression 6 in front face 4, an intermediate cylindrical portion 8 and a rear face 10.

Referring to FIG. 3, tablet 2 has a maximum diameter d4 of 18 mm. The depth direction of the tablet is perpendicular to the diameter direction and extends between front face 4 and rear face 10. Referring to FIG. 6, tablet 2 has a maximum dimension h2 of 5.1 mm in the depth direction.

Front face 4 of the tablet is generally in the shape of a spherical cap provided with concave depression 6. The front face of the tablet has a maximum depth of 2.5 mm. The spherical cap portion has a diameter of 18 mm; this is where it meets the circular front face of intermediate cylindrical portion 8.

Referring to FIGS. 3 and 6, concave depression 6 has a maximum diameter d6 of 9 mm and a maximum depth of 1 mm. This reduces the depth of tablet 2 to 4.1 mm being its minimum dimension h6 in the depth direction.

Intermediate cylindrical portion 8 has a depth of 2 mm and a diameter of 18 mm.

Rear face 10 has a smaller diameter than intermediate cylindrical portion 8 as a result of a circumferential angled edge portion 12, providing a frustrum shape. The depth of the rear face is 0.6 mm. Referring to FIG. 6, the angled edge portion 12 makes an angle A of 30 degrees with the circular rear face of intermediate cylindrical portion 8.

The rear face of the tablet is substantially-planar. It may be provided with one or more indentations in the shape of a brand logo, for example. In one example, rear face 10 is provided with 8 cylindrical indentations, each having a depth of 0.2 mm and a diameter in the range of 0.8 mm to 1.7 mm.

The maximum depth h2 of tablet 2 is the sum of the maximum depth of front 4 (2.5 mm), the depth of intermediate cylindrical portion 8 (2 mm) and the depth of rear face 10 (0.6 mm).

In this embodiment, the minimum dimension h6 of the tablet in the depth direction is approximately 80% of the maximum dimension h2 of the tablet in the depth direction.

Also, with reference to FIG. 3, the maximum dimension d6 of the depression in the direction which is perpendicular to the depth direction is 9 mm (its diameter) which is 50% of the dimension d4 of the tablet in the same direction (its diameter of 18 mm).

Further details of the geometry of the tablet of this embodiment being a new tablet of ZIMA DENTAL™ are set out below and compared to the geometry of the old tablet of ZIMA DENTAL™

Volume of new tablet of ZIMA DENTAL™ (SHAPE A)

For the purpose of this calculation, Shape A is separated into 3 distinct shapes;
A curved minor segment of a sphere with a concave depression or dimple (the cap)
A cylinder
A frustum (the bottom portion)

### Volume of the Cap

Referring to FIG. 7, the volume of the cap is calculated by assuming the cap is a minor segment of a first sphere, with the depression created by the minor segment of a second sphere removing volume from it.

The volume of the cap EQUALS the volume of the larger minor segment of the first sphere LESS the volume of a smaller minor segment of the first sphere LESS the volume of the minor segment of the second sphere

$$\begin{matrix}R = Radius of sphere ( mm ) \\ C = Chord Length of segment ( mm ) \\ H = Height of segment ( mm ) \\ Where C = 18 mm and H = 3.5 mm \\ H = 2. 5 + 0.5 ( assumed height of theoretical spherical cap )\end{matrix}$$

For this calculation, it is assumed that the height of the smaller minor segment is 0.5 mm (this is where the depression is located). Given the distance between the chord lengths is 2.5 mm, this is a reasonable assumption.

### Volume of Larger Minor Segment (First Sphere):

$$\begin{matrix}{V}_{c a p} = \frac{π {H}^{2}}{3} ( 3 R - H ) \\ R = \frac{{H}^{2} + {( \frac{C}{2} )}^{2}}{2 H} \\ R = \frac{{H}^{2} + {( \frac{C}{2} )}^{2}}{2 H} = \frac{{3}^{2} + {( \frac{18}{2} )}^{2}}{2 * 3} = 15 mm \\ {V}_{( Large segment )} = \frac{π {H}^{2}}{3} ( 3 R — H ) = \frac{π {3}^{2}}{3} ( 3 * 15 — 3 ) = 39 5.84 {mm}^{3}\end{matrix}$$

### Volume of Smaller Minor Segment (First Sphere):

$${V}_{( S mall segment )} = \frac{π {H}^{2}}{3} ( 3 R - H ) = \frac{π 0 . {5}^{2}}{3} ( 3 * 15 - 0.5 ) = 11.65 {mm}^{3}$$

### Volume of Depression (Second Sphere):

$$Where C = 9 mm and H = 1 mm$$

$${V}_{c a p} = \frac{π {H}^{2}}{3} ( 3 R - H )$$

$$R = \frac{{H}^{2} + {( \frac{C}{2} )}^{2}}{2 H} = \frac{{1}^{2} + {( \frac{9}{2} )}^{2}}{2 * 1} = 10.6 \; 25 mm$$

$${V}_{d i m p l e} = \frac{π {H}^{2}}{3} ( 3 R - H ) = \frac{π {1}^{2}}{3} ( 3 * 10.625 - 1 ) = 32.33 {mm}^{3}$$

### Volume of Cap (Top Portion):

$${V}_{c a p} = 395.84 - 11.65 - 32.33 = 3 51.86 {mm}^{3}$$

### Volume of Cylinder (Intermediate Portion):

$$Where H = 2 mm and R = 9 mm$$

$${V}_{c y l i n d e r} = π {R}^{2} H$$

$${V}_{c y l i n d e r} = {π ( 9 )}^{2} ( 2 )$$

$${V}_{c y l i n d e r} = 5 8.94 {mm}^{3}$$

### Volume of Circular Frustum (Bottom Portion):

$$Where R 1 = 9 mm , H = 0.6 mm and θ = 30 °$$

$${V}_{F r u s t u m} = \frac{1}{3} π H ( {( R 1 )}^{2} + R 1 R 2 + {( R 2 )}^{2} )$$

Horizontal distance (d) between the taper R1 and R2 is below;

$$d = H * tan ( θ )$$

$$d = 0. 6 * tan ( 30 ) = 0.3 \; 464 mm$$

$$R2 = R 1 - d = 9 - 0.3464 = 8.6 \; 536 mm$$

$$V = \frac{1}{3} π 0.6 ( {( 9 )}^{2} + 9 * 8.6536 + {( 8.6536 )}^{2} ) = 146.88 mm \hat{} 3$$

### Total Volume of Shape a Tablet

$$351.86 {mm}^{3} + 5 8.94 {mm}^{3} + 1 46.88 {mm}^{3} = 10 0.68 {mm}^{3}$$

### Surface Area of New Tablet of ZIMA DENTAL™ (SHAPE A)

### Surface Area of the Cap

The surface area of the cap EQUALS the surface area of the larger segment of the first sphere LESS the surface area of the smaller segment of the first sphere PLUS the surface area of the minor segment of the second sphere.

$$Area of segment in sphere = 2 π RH$$

### Surface Area of Larger Segment (First Sphere):

$$Area of segment in sphere = 2 π * 15 * 3 = 2 82.74 {mm}^{2}$$

### Surface Area of Smaller Segment (First Sphere):

$$Area of segment in sphere = 2 π * 15 * 0.5 = 47.12 {mm}^{2}$$

### Surface Area of Depression (Second Sphere):

$$Area of segment in sphere = 2 π * 10.625 * 1 = 66.76 {mm}^{2}$$

### Surface Area of Cap (Top Portion):

$$Surface area of cap = 282.74 - 47.12 + 66.76 {mm}^{2} = 3 2.38 {mm}^{2}$$

### Surface Area of Cylinder (Intermediate Portion):

$$A = 2 π RH$$

$$A = 2 π * 9 * 2 = 1 13.1 {mm}^{2}$$

### Surface Area of Circular Frustum (Bottom Portion):

$$A ( face ) = {π ( R 2 )}^{2} = {π ( 8.636 )}^{2} = 2 32.26 {mm}^{2}$$

$$A ( lateral sides ) = π ( R 1 + R 2 ) L$$

Where L is the lateral side length;

$$L = π \sqrt{{H}^{2} + {( R 1 + R 2 )}^{2}}$$

$$L = π \sqrt{{0.6}^{2} + {( 9 + 8.636 )}^{2}} = 0.693 mm$$

$$A ( lateral sides ) = π ( 9 + 8.636 ) * 0.693 = 38.42 {mm}^{2}$$

$$Therefore$$

$$Area ( bottom section ) = 235.26 + 38.42 = 2 73.68 {mm}^{2}$$

### Total Surface Area of Shape a Tablet

$$Total surface area of tablet = 302.38 + 273.68 + 113.1 = 6 89.16 {mm}^{2}$$

### Surface Area to Volume Ratio of Shape a Tablet

$$\frac{Total surface area}{Total Volume} = \frac{6 89.16 {mm}^{2}}{10 7.68 {mm}^{3}} = 0.6 \; 84 / m$$

### Volume of Old Tablet of ZIMA DENTAL™ (SHAPE B)

Referring to FIGS. 8 and 9, the dimensions of this tablet are as follows:

$$Tablet height = 5.082 mm$$

$$Tablet diameter BD 1 = 23 mm$$

$$Tablet face diameter BD 2 = 19.268 mm$$

### Volume of Shape B

For the purpose of this calculation, Shape B is separated into 3 distinct shapes;

$$A Frustum or flat cone with height BH 1 = 0.5 mm ( “ Frustum 1 ” )$$

$$A Cylinder with height BH 2 = 4 mm$$

$$A Frustum or flat cone with height BH 3 = 0.582 mm ( “ Frustum 2 ” )$$

### Volume of Cylinder

$${V}_{cylinder} = π {r}_{out}^{2} h$$

$${V}_{cylinder} = {π ( \frac{23}{2} )}^{2} * ( 4 )$$

$${V}_{cylinder} = 1 661.9 {mm}^{3}$$

### Volume of Circular Frustums

$${V}_{Frustum} = \frac{π H}{3} ( {a}^{2} + a b + {b}^{2} )$$

Where a=radius of larger face, b=radius of smaller face and h=height of frustum

$${V}_{F r u stum 1} = \frac{π 0.5}{3} ( {( \frac{23}{2} )}^{2} + ( \frac{23}{2} ) * ( \frac{19.268}{2} ) + {( \frac{19.268}{2} )}^{2} ) = 1 75.85 {mm}^{3}$$

$${V}_{F r u stum 2} = \frac{π 0.582}{3} ( {( \frac{23}{2} )}^{2} + ( \frac{23}{2} ) * ( \frac{19.268}{2} ) + {( \frac{19.268}{2} )}^{2} ) = 2 4.69 {mm}^{3}$$

### Total Volume of Shape B Tablet

$$Volume = 1661.9 + 175.85 + 204.69 = 2042.45 {mm}^{3}$$

### Surface Area of Old Tablet of ZIMA DENTAL™ (SHAPE B)

Here the surface area EQUALS the surface area of the sides of the cylinder PLUS the surface area of the circular frustums.

### Surface Area of Cylinder

$$A = 2 π RH$$

$$A = 2 π * ( \frac{23}{2} ) * 4 = 2 89.03 {mm}^{2}$$

Surface Area of circular frustums

### Frustum 1 (H=0.5)

$$A ( face ) = {π ( R )}^{2} = {π ( \frac{19.268}{2} )}^{2} = 2 91.58 {mm}^{2}$$

$$A ( lateral sides ) = π ( R 1 + R 2 ) L$$

Where L is the lateral side length;

$$L = π \sqrt{{H}^{2} + {( R 1 + R 2 )}^{2}}$$

$$L = π \sqrt{0. {5}^{2} + {( \frac{19.268}{2} + \frac{23}{2} )}^{2}} = 1.93 mm$$

$$A ( lateral sides ) = π ( \frac{19.268}{2} + \frac{23}{2} ) * 1.93 = 1 28.26 {mm}^{2}$$

### Frustum 2 (H=0.582)

$$A ( face ) = {π ( R )}^{2} = {π ( \frac{19.268}{2} )}^{2} = 2 91.58 {mm}^{2}$$

$$A ( lateral sides ) = π ( R 1 + R 2 ) L$$

Where L is the lateral side length;

$$L = π \sqrt{{H}^{2} + {( R 1 + R 2 )}^{2}}$$

$$L = π \sqrt{0.58 {2}^{2} + {( \frac{19.268}{2} + \frac{23}{2} )}^{2}} = 1.95 mm$$

$$A ( lateral sides ) = π ( \frac{19.268}{2} + \frac{23}{2} ) * 1.95 = 1 29.78 {mm}^{2}$$

$$Surface Area ( Frustums ) = 2 * 29 \; 1.58 + 128.26 + 129.78 = 8 41.2 {mm}^{2}$$

### Total Surface Area of Shape B Tablet

$$Total surface Area = 84 \; 1.20 + 289.03 = 11 30.23 {mm}^{2}$$

### Surface Area to Volume Ratio of Shape B Tablet

$$\frac{Total surface area}{Total Volume} = \frac{1130.23 {mm}^{2}}{20 42.45 {mm}^{3}} = 0.5 \; 53 / m$$

These calculations demonstrate that Shape A has a larger surface area to volume ratio (0.684/m) than Shape B (0.553/m). The new tablet of ZIMA DENTAL™ has a surface area to volume ratio which is more than 20% greater than that of the old tablet of ZIMA DENTAL™.

The table below is an example of the effervescent cleaning composition of the tablet of the present invention. Its composition is compared with the composition of two prior art cleaning tablets.

| | | Weight percentage | | Weight percentage | | Weight percentage | |
|---|---|---|---|---|---|---|---|
| | | wt % - new tablet | | wt % - old tablet | | wt % - tablet | |
| | | ZIMA | | ZIMA | | RETAINER | |
| Ingredient | Role | DENTAL ™ | | DENTAL ™ | | FRESH ™ | |
| Sodium Bicarbonate | Effervescing | 27.0 | | 22.6 | | 44.8 | |
| | agent | | | | | | |
| Citric Acid | Effervescing | 27.5 | | 5.7 | | 25.7 | |
| | agent | | | | | | |
| Sodium carbonate | Effervescing | 14.0 | | 21.3 | | 0.0 | |
| | agent | | | | | | |
| Sodium percarbonate | Oxidising | 15.0 | | 25.0 | | 10.2 | |
| | agent | | | | | | |
| Sodium sulphate | Filler | 3.0 | | 10.0 | | 0.0 | |
| Potassium sulphate | Filler | 2.0 | | 5.3 | | 0.0 | |
| Peppermint oil | Taste and | 0.5 | | Alternative mint oil | | 1.7 | |
| | anti-microbial | | | Menthol 0.1 | | | |
| Maltodextrin | Binder | 9.0 | | 0.0 | | 0.0 | |
| Disodium cocoyl | Surfactant | 2.0 | | 0.0 | | 0.0 | |
| glutamate | | | | | | | |
| Sodium | Surfactant | 0.0 | | 5.0 | | 0.0 | |
| dodecylbenzenesulfonate | | | | | | | |
| Sodium Dodecyl | Surfactant | 0.0 | | 0.0 | | 1.2 | |
| Sulphate | | | | | | | |
| Polyvinylpyrrolidone | Dispersing | 0.0 | | 4.0 | | 0.0 | |
| (K30) | agent | | | | | | |
| Lactose | Carrier | 0.0 | | 1.0 | | 0.0 | |
| Potassium | Oxidising | 0.0 | | 0.0 | | 12.6 | |
| peroxymonosulphate | agent | | | | | | |
| Sodium Benzoate | Preservative | 0.0 | | 0.0 | | 1.2 | |
| Other ingredients | | | | | | 2.6 | |
| (PEG-150, TAED, Indigo) | | | | | | | |
| Weight of single tablet | | 1.56 | g | 2.48 | g | 2.8 | g |
| Concentration in | | 10.4 | g/L | 16.53 | g/L | 18.66 | g/L |

150 ml water

The present inventor has found that by providing lower concentrations of dissolvable solids in an effervescent tablet, resulting in a solution which is less dense than those provided by the prior art tablets, cavitation can be encouraged during ultrasonic cleaning.

Also, the bubbles created by the effervescent system lower the threshold for cavitation bubbles to form during ultrasonic cleaning. This improves the cleaning effect.

In this respect, the present invention seeks to encourage the formation of lower energy bubbles, rather than bigger powerful bubbles, as lower energy bubbles have been found to provide a more thorough cleaning effect for delicate oral appliances.

The old tablet from ZIMA DENTAL™ contains the surfactant Sodium Dodecylbenzenesulfonate SDBS. The tablet of the present invention contains the surfactant Disodium Cocoyl Glutamate. The RETAINER FRESH™ tablet contains the surfactant Sodium Dodecyl Sulphate SDS (also known as SLS—sodium lauryl sulphate). Surfactants lower water tension of the solution which is important to enhance the ultrasonic cleaning effect.

Sodium Dodecylbenzenesulfonate at 5% is a high-foaming surfactant that produces dense, stable foam, making it significantly more prone to excessive foaming compared to 1.2% Sodium Dodecyl Sulfate, which is also a high-foaming agent but with slightly less foam production at this lower concentration.

In contrast, in the tablet of the present invention, Disodium Cocoyl Glutamate at 2% is a much milder surfactant that produces moderate, softer foam, which breaks down faster and generates less foam overall. In ultrasonic cleaning, the present inventor has found that excessive foam, particularly from high-foaming agents like SDBS or SDS, disrupts the process by dampening the sound waves, reducing the formation of cavitation bubbles, and impeding the cleaning action, whereas Disodium Cocoyl Glutamate, being a lower-foaming agent, is less likely to cause such issues.

Disodium Cocoyl Glutamate is a surfactant derived from coconut oil, used for its cleansing properties, helping to break down and remove debris. The effervescent cleaning composition of the present invention may comprise 0.7 to 2.5 wt % of this ingredient.

The oxidising agent used, sodium percarbonate, releases hydrogen peroxide when dissolved in water, which helps to remove stains and to disinfect. Ultrasonic waves help to distribute the peroxide evenly throughout the cleaning solution ensuring all areas of oral appliances are exposed to peroxide, a common issue due to their complicated structure. The effervescent cleaning composition of the present invention may comprise 12 to 22 wt % of this ingredient.

Sodium bicarbonate acts as a mild abrasive for physical cleaning and can neutralize acids produced by bacteria in the mouth, thus maintaining a substantially neutral pH. The abrasive cleaning action works synergistically with ultrasonic cleaning. The effervescent cleaning composition of the present invention may comprise 18 to 28 wt % of this ingredient.

Sodium carbonate helps to remove stains and can act as a buffering agent against citric acid to maintain a desired pH level which is typically neutral or slightly alkaline (eg pH 7 to 9). The effervescent cleaning composition of the present invention may comprise 12 to 22 wt % of this ingredient.

Citric acid is used as a chelating agent that can bind to calcium and other minerals, making it easier to clean away plaque and tartar. It is also part of the effervescent system that helps to distribute the cleaning agents evenly. The effervescent cleaning composition of the present invention may comprise 22 to 32 wt % of this ingredient.

Sodium sulphate is generally used as a filler but also helps the tablet dissolve and release the active ingredients more effectively. The effervescent cleaning composition of the present invention may comprise 3 to 9 wt % of this ingredient.

Potassium sulphate is generally used as a filler or stabilizer. The effervescent cleaning composition of the present invention may comprise 2 to 9 wt % of potassium sulphate.

These water softeners (sodium and potassium sulphate) prevent mineral deposits from diminishing the efficiency of the surfactants and the oxidizing agents.

Peppermint oil provides a pleasant taste and fragrance, and may also have mild antiseptic properties. The flavour is evenly distributed throughout the solution by ultrasonic waves. The effervescent cleaning composition of the present invention may comprise 0.1 to 1.0 wt % of this ingredient.

Maltodextrin binds the tablet together but quickly dissolves in water. The effervescent cleaning composition of the present invention may comprise 8 to 18 wt % of this ingredient.

When sodium percarbonate dissolves in water, it releases hydrogen peroxide, an effective bleaching agent. Citric acid lowers the pH of the solution, which can help to stabilize the hydrogen peroxide, allowing it to act more effectively before it decomposes into water and oxygen.

Sodium carbonate and sodium bicarbonate react with citric acid to produce carbon dioxide gas, contributing to the effervescent action of the tablet. This effervescence can aid in the mechanical removal of debris from the appliances.

The effervescent cleaning composition of the present invention provides a weaker solution (reduced concentration) and lower surface tension than the prior art tablets, encouraging a higher volume of cavitation bubbles to form, despite using a lower concentration of surfactant(s). It can be appreciated that the tablet of the present invention is significantly lower in weight than the old tablet from ZIMA DENTAL™ but has increased effervescence and this also enhances the cavitation effect.

Moreover, the presence of the depression in the tablet enhances the cleaning of oral appliances in an ultrasonic cleaning device compared to the prior art effervescent tablets by providing an aperture in the tablet when it is dissolving, by concentrating the bubble stream and by increasing the surface area to volume ratio of the tablet.

This is demonstrated by the following examples and comparative examples which investigate how different tablets (the old tablet from ZIMA DENTAL™ and the new tablet from ZIMA DENTAL™) affect the ultrasonic cleaning frequency in an ultrasonic cleaning device.

Using a hydrophone, the fundamental frequency (Fₒ) was measured under four conditions: (1) the ultrasonic cleaning device alone, (2) the ultrasonic cleaning device with the old tablet, (3) the ultrasonic cleaning device with the new tablet, and (4) the new tablet alone, ie without the application of ultrasound.

When tablets were used, these were placed vertically below the hydrophone at the start time.

Testing the ultrasonic cleaning device and the new tablet separately provided important baseline readings and confirmed, for example, that the new tablet by itself did not generate its own measurable ultrasonic activity.

The tables below set out the fundamental frequency Fₒ in KHz experienced by a hydrophone during the application of ultrasound in an ultrasonic cleaning device at intervals of approximately 10 seconds. An oral appliance being cleaned in the ultrasonic cleaning device would experience equivalent fundamental frequencies.

TABLE 1
Ultrasonic cleaning device alone

| Time (seconds) | F₀ |
|---|---|
| 42 | 42.7 |
| 51 | 42.7 |
| 61 | 42.7 |
| 71 | 42.7 |
| 81 | 42.6 |
| 91 | 42.7 |
| 101 | 42.7 |
| 111 | 42.7 |
| 121 | 42.7 |
| 131 | 42.7 |
| Mean | 42.7 |
| Stdev | 0 |
| % Stdev | 0.1 |
| Max | 42.7 |
| Min | 42.6 |

TABLE 2
Ultrasonic cleaning device + Old Tablet

| Time (seconds) | F₀ |
|---|---|
| 12 | 86 |
| 21 | 86.1 |
| 31 | 42.9 |
| 41 | 42.8 |
| 51 | 42.8 |
| 61 | 42.9 |
| 71 | 42.9 |
| 81 | 42.9 |
| 91 | 42.8 |
| 101 | 42.7 |
| Mean | 51.5 |
| Stdev | 18.2 |
| % Stdev | 35.4 |
| Max | 86.1 |
| Min | 42.7 |

TABLE 3
Ultrasonic cleaning device + New Tablet

| Time (seconds) | F₀ |
|---|---|
| 10 | 42.7 |
| 19 | 128.8 |
| 29 | 128.6 |
| 39 | 128.7 |
| 49 | 128.6 |
| 50 | 42.6 |
| 69 | 42.7 |
| 79 | 128.3 |
| 89 | 128.5 |
| 99 | 128.4 |
| Mean | 102.8 |
| Stdev | 41.5 |
| % Stdev | 40.3 |
| Max | 128.8 |
| Min | 42.6 |

TABLE 4
New Tablet Only

| Time (seconds) | F₀ |
|---|---|
| 1 | 0 |
| 10 | 0 |
| 20 | 0 |
| 30 | 0 |
| 40 | 0 |
| 50 | 0 |
| 60 | 0 |
| 70 | 0 |
| 80 | 0 |
| 90 | 0 |
| Mean | 0 |
| Stdev | 0 |
| % Stdev | 0 |
| Max | 0 |
| Min | 0 |

### Experimental Conditions

The experiments were performed in a Zima Dental™ Dental Pod ultrasonic device and the frequency measurement were performed using the OndoSonics™ Hydrophone HCT-0320 used with the Ondasonics™ MCT-2000 Acoustic Cavitation Meter (from Onda Corp, USA).

### System Information

| | |
|---|---|
| Meter_Model: | MCT-2000 |
| Meter_S/N: | 0112 |
| Firmware_version: | 0.2.20 |
| Hydrophone_SN: | HCT-0320-1374 |
| Calibration_Date: | 2024 Apr. 2 |
| Matching_Gain: | Disabled |
| Matching_Gain_Filename: | N/A |
| Frequency Detection: | Disabled |

### Record Info

| Mode: | LOG | |
|---|---|---|
| Log-Time: | 99 | sec |
| Log-Rate: | 1/10 | sec |
| Averaging_Time: | 2 | sec |

| | |
|---|---|
| Save_Spectrum: | Yes |
| Save_Waveform: | No |

### The Statistical Test

A two-sample t-test was used to determine that any observed differences were genuine. The test compared, for example, the average Fₒ for the experiment of Table 2 with the average Fₒ for the experiment of Table 3. This test takes into account how much the measurements vary within each group (their standard deviations). Since the baseline readings (Tables 1 and 4) were clearly different from the readings of Tables 2 and 3, this strengthened the conclusion that the new tablet drives the changes to the ultrasonic frequency. The resulting t-test showed a large enough gap between the old tablet frequencies and the new tablet frequencies—and small enough variation within each group—that the difference was statistically significant.

### The Implication

Since the new tablet alone showed no ultrasonic activity (Table 4), and the ultrasonic cleaning device alone had a notably different frequency range (Table 1), it's clear that the new tablet alters how the ultrasound behaves rather than contributing its own ultrasonic signal.

Statistically, the new tablet meaningfully shifts the operating frequency of the ultrasonic cleaning device. In Table 3, it can be seen that the new tablet increases the fundamental frequency from 42.7 kHz to over 128 kHz and that this increase of approximately 300% is sustained over 80 seconds. Over the course of the experiment the mean frequency was 102.6 Hz, approximately a 240% increase in the fundamental frequency over the 100 seconds of the experiment. In contrast, in Table 2, it can be seen that the old tablet increases the fundamental frequency from 42.7 kHz to 86 kHz and that this increase is sustained over 10 seconds and then returns to the baseline fundamental frequency of around 42.7 kHz.

The new tablet therefore has a superior modulation effect, raising the fundamental frequency by about 300% and sustaining this effect over a significant time period (cleaning cycles are generally a few minutes long as set out herein).

This superior modulation effect is the result of the properties of the new tablet. As mentioned above, the presence of the depression in the face of the tablet increases the surface area so that the tablet dissolves inwardly, improving its stability and forming an aperture to release bubbles. A concentrated stream of rising bubbles envelops the oral appliance (or hydrophone in the experiment) and the ultrasonic waves are modulated by the presence of these bubbles, resulting in a thorough cleaning of the oral appliance.

In contrast, prior art tablets such as the old tablet used in the experiment, do not provide such a critical mass of bubbles to cause modulation of the ultrasonic waves which is so effective. Moreover, their positioning is not stable (they tend to float around in the liquid). Hence, the superior cleaning effect provided by the present invention is not achieved in the prior art.

Another example of the effervescent cleaning composition of the tablet of the present invention is as follows:

| | | Weight | |
|---|---|---|---|
| Ingredient | Role | percentage - wt % | |
| Sodium percarbonate | Oxidising agent | 18.50 | |
| Sodium bicarbonate | Effervescing agent | 22.03 | |
| Sodium carbonate | Effervescing agent | 14.56 | |
| Sodium sulphate | Filler | 4.00 | |
| Citric acid | Effervescing agent | 23.42 | |
| Potassium sulphate | Filler | 2.91 | |
| Potassium sorbate | Preservative | 2.91 | |
| Disodium cocoyl glutamate | Surfactant | 2.43 | |
| Maltodextrin | Binder | 8.74 | |
| Peppermint oil | Taste and | 0.50 | |
| | anti-microbial | | |
| Weight of single tablet | | 1.6 | g |
| Concentration in 150 ml water | | 10.67 | g /L |

Potassium sorbate is included in this composition to increase shelf-life and to ensure that the performance of the product remains stable from production to consumer use. Potassium sorbate can inhibit bacteria and mould growth, prevent caking and odour generation in the tablets during storage.

1. An effervescent cleaning composition in the form of a tablet for the cleaning of oral appliances in an ultrasonic cleaning device,
wherein the tablet has a first face and a second face, the first face and the second face opposing one another in a depth direction of the tablet,
wherein the first face is provided with a depression,
wherein the depression provides the tablet with a minimum dimension in the depth direction that is 50 to 90% of the maximum dimension of the tablet in the depth direction, and
wherein the maximum dimension of the depression in a direction which is perpendicular to the depth direction is 30 to 70% of the maximum dimension of the tablet in the same direction, being a direction perpendicular to the depth direction.

2. An effervescent cleaning composition in the form of a tablet as claimed in claim 1,
wherein the minimum dimension of the tablet in the depth direction is 70 to 90% of the maximum dimension of the tablet in the depth direction.

3. An effervescent cleaning composition in the form of a tablet as claimed in claim 1,
wherein the maximum dimension of the depression in the direction which is perpendicular to the depth direction is 40 to 60% of the maximum dimension of the tablet in the same direction, being a direction perpendicular to the depth direction.

4. An effervescent cleaning composition in the form of a tablet as claimed in claim 1,
wherein the depression is located substantially-centrally in the first face of the tablet.

5. An effervescent cleaning composition in the form of a tablet as claimed in claim 1,
wherein the depression is concave.

6. An effervescent cleaning composition in the form of a tablet as claimed in claim 1,
wherein the depression is circular in plan view.

7. An effervescent cleaning composition in the form of a tablet as claimed in claim 1,
wherein the first face has the shape of a spherical cap with the depression provided therein.

8. An effervescent cleaning composition in the form of a tablet as claimed in claim 1,
wherein the depression has the shape of a spherical cap.

9. An effervescent cleaning composition in the form of a tablet as claimed in claim 1,
wherein the second face of the tablet is substantially planar.

10. An effervescent cleaning composition in the form of a tablet as claimed in claim 1,
wherein the tablet has a weight in the range of 1 to 2 g.

11. An effervescent cleaning composition in the form of a tablet as claimed in claim 1,
wherein the tablet has a surface area to volume ratio of more than 0.6/m.

12. An effervescent cleaning composition in the form of a tablet as claimed in claim 1,
wherein the composition comprises at least one oxidising agent, at least one surfactant and effervescing agents.

13. An effervescent cleaning composition in the form of a tablet as claimed in claim 12,
wherein the composition comprises 60 to 75 wt % effervescing agents.

14. An effervescent cleaning composition in the form of a tablet as claimed in claim 12,
wherein the effervescing agents comprise at least one organic carboxylic acid and at least one alkali metal carbonate and/or alkali metal bicarbonate.

15. An effervescent cleaning composition in the form of a tablet as claimed in claim 1,
wherein the composition comprises 0.7 to 2.5 wt % of Disodium Cocoyl Glutamate as a surfactant.

16. An effervescent cleaning composition in the form of a tablet as claimed in claim 1,
wherein the tablet is adapted to dissolve in water and wherein the tablet is configured such that, as it dissolves in use, an aperture is formed in the tablet in the depth direction at the site of the depression.

17. Use of an effervescent cleaning composition in the form of a tablet, as claimed in claim 1, in an ultrasonic cleaning device for the cleaning of oral appliances.

18. An effervescent cleaning composition in the form of a tablet as claimed in claim 1 and an ultrasonic cleaning device, wherein the device comprises a tank and an ultrasonic transducer to convey ultrasonic waves to the tablet and a liquid in the tank.

19. An ultrasonic cleaning method for oral appliances using an effervescent cleaning composition in the form of a tablet as claimed in claim 1 and an ultrasonic cleaning device, the method comprising:
introducing the tablet, liquid and one or more oral appliances into the ultrasonic cleaning device;
driving an ultrasonic transducer of the ultrasonic cleaning device; and
vibrating the liquid with ultrasonic waves and dissolving the tablet in the liquid to clean the or each oral appliance.

20. An ultrasonic cleaning method for oral appliances using an effervescent cleaning composition in the form of a tablet as claimed in claim 1 and an ultrasonic cleaning device, the method comprising:
introducing a liquid and one or more oral appliances into the ultrasonic cleaning device, driving an ultrasonic transducer of the ultrasonic cleaning device for a first period of time, vibrating the liquid with ultrasonic waves to clean the or each oral appliance during the first period,
adding the tablet to the liquid in the ultrasonic cleaning device after the first period, driving the ultrasonic transducer of the ultrasonic cleaning device for a second period of time, and vibrating the liquid with ultrasonic waves while dissolving the tablet in the liquid to clean the or each oral appliance during the second period.

21. An ultrasonic cleaning method as claimed in claim 20, wherein the ultrasonic transducer of the ultrasonic cleaning device is driven for a second period of time substantially concomitantly with the addition of the tablet to the liquid.

22. An ultrasonic cleaning method as claimed in claim 20, wherein the first period and the second period are each from 1 to 5 minutes long, preferably from 2 to 3 minutes long.
